(19) United States
(12) Patent Application Publication
(10) Pub. No.: US 2003/0015360 A1
(43) Pub. Date: Jan. 23, 2003

(54) Electric wheel motor assembly

(76) Inventor: Arnaud Michel Villeneuve, Vernouillet (FR)

Correspondence Address: Robert P. Renke, Suite 250, 28333 Telegraph Road, Southfield, MI, 48034, US

(21) Appl. No.: 10/198,428

(22) Filed: Jul. 17, 2002

(30) Foreign Application Priority Data
Jul. 20, 2001 (GB) 0117681.7

(51) Int. Cl. B60K 1/02

(52) U.S. Cl. 180/65.6

(57) ABSTRACT

An electric motor assembly including a hub, a wheel rim having a rotary axis mounted on the hub to be rotatable about the rotary axis, a sun gear fixed to the hub or an annulus gear fixed to the rim, two or more electric motors each having a stator and a rotor, the rotors being rotatable about rotary axes parallel to the rotary axis of the rim, the stators of the motors being fixed to the rim if a sun gear is provided or fixed to the hub if an annulus gear is provided and being spaced apart equi-angularly around the rotary axis of the rim, and a planet gear driven by each rotor, each planet gear engaging the sun gear or the annulus gear whereby, when the rotors rotate, the rim is rotated on the hub about its rotary axis.

### TECHNICAL FIELD

This invention relates to an electric wheel motor assembly, i.e. a wheel which is driven by electric motors mounted on the wheel.

### BACKGROUND OF THE INVENTION

There have been many proposals for mounting electric motors on wheels to drive them. Normally there is a single electric motor which drives a wheel through an epicyclic gear box, which can be heavy. Thus, there exists a need for an improved electric wheel motor assembly.

### SUMMARY OF THE INVENTION

According to the invention, we provide an electric motor assembly including a hub, a wheel rim having a rotary axis mounted on the hub to be rotatable about the rotary axis, a sun gear fixed to the hub or an annulus gear fixed to the rim, two or more electric motors each having a stator and a rotor, the rotors being rotatable about rotary axes parallel to the rotary axis of the rim, the stators of the motors being fixed to the rim if a sun gear is provided or fixed to the hub if an annulus gear is provided and being spaced apart equi-angularly around the rotary axis of the rim, and a planet gear driven by each rotor, each planet gear engaging the sun gear or the annulus gear whereby, when the rotors rotate, the rim is rotated on the hub about its rotary axis.

Where there is a sun gear, the rim may be supported on the hub by the stators of the motors which may be connected together by a ring at their radially inner ends, there being a bearing between the ring and the hub. Where there is an annulus gear, the stators are fixed to the hub and the rim is carried by a disc which carries the annulus gear and is mounted on the hub by a bearing.

Preferably, the electric motors are of the pancake type. There must be at least two motors but there could be three or more so long as they are equi-angularly spaced about the rotary axis of the wheel.

Other advantages and features of the invention will also become apparent upon reading the following detailed description and appended claims, and upon reference to the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention.

In the drawings:

FIG. 1 is a cross-section through an electric wheel motor assembly according to a first embodiment of the invention.

FIG. 2 is a similar cross-section to FIG. 1 showing a second embodiment of the invention.

FIG. 3 is a view similar to FIGS. 1 and 2 of a third embodiment of the invention.

### DETAILED DESCRIPTION OF THE INVENTION

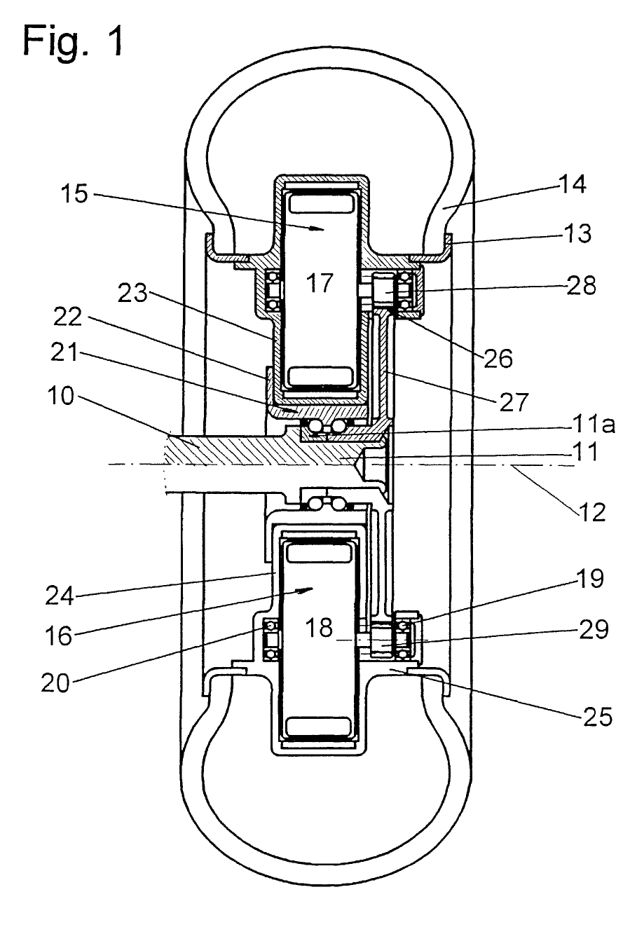

Referring to FIG. 1, the assembly comprises a shaft 10 providing a hub 11. Mounted on the hub 11 for rotation about its rotary axis 12 is a wheel rim 13 carrying a tire 14. Two electric motors 15 and 16 are arranged to drive the rim 13 and are equi-angularly spaced about the rotary axis 12 when viewed along the axis. The motors 15, 16 are of the pancake type, the rotors of the motors 15 and 16 being indicated at 17 and 18, respectively. Each rotor 17, 18 is mounted in a pair of spaced ball bearings shown for the rotor 18 at 19 and 20 and which are carried by a supporting structure. The rotors 17, 18 are rotatable about respective rotary axes parallel to the rotary axis 12 of the wheel rim 13.

The supporting structure comprises a cylindrical motor support 21 having a flange 22. The motor support 21 is mounted on the hub 11 by means of a double-row ball bearing 11a of which the motor support 21 forms the outer race. The motor support 21 supports stators 23 and 24 of the motors 15 and 16. Each stator 23, 24 has a flange such as the flange 25 shown for the stator 24, which closes the bottom of the rim 13. Between the motors 15 and 16, the bottom of the rim 13 is closed by a ring.

A sun gear 26 has a central portion 27 which is fixed to the hub 11 and forms an inner race of one of the rows of balls of the bearing 11a. Each of the rotors 17 and 18 carries a planet gear 28 or 29 which engages with the sun gear 26. It will be seen that if the rotors 17 and 18 rotate they will drive the planet gears 28 and 29 and these will run round the stationary sun gear 27 and drive the rim 13. The gear box of the assembly is thus integrated into the wheel structure. The gear ratio of the gearing can be varied within a wide range.

The electric motors 15 and 16 are preferably of the pancake type which fit well within the rim 13. As shown in FIG. 1 the stators 23, 24 of the motors 15, 16 may extend into the air space of the tire 14.

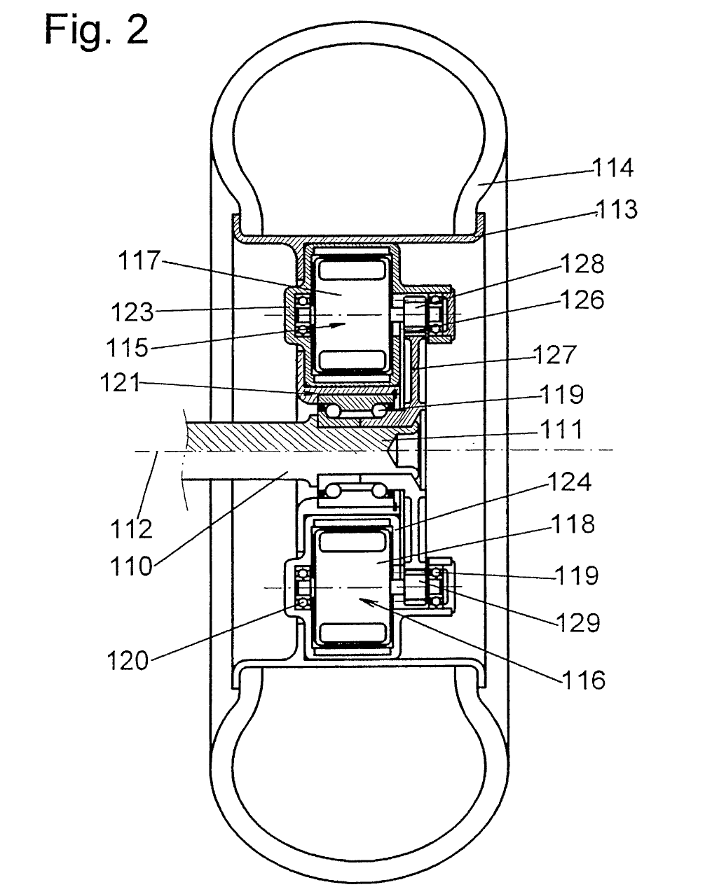

In FIG. 2 the motors 115, 116 are of smaller diameter than those shown in FIG. 1 and do not extend into the airspace of the tire 114. That is, the motors 115, 116 do not extend radially beyond the joint between the tire and wheel rim. As a result, the stators 123, 124 of the motors 115, 116 fit within the wheel rim 113. Otherwise, the construction of FIG. 2 is identical to that of FIG. 1 and similar parts in FIG. 2 to those in FIG. 1 have the same reference numerals indexed by 100.

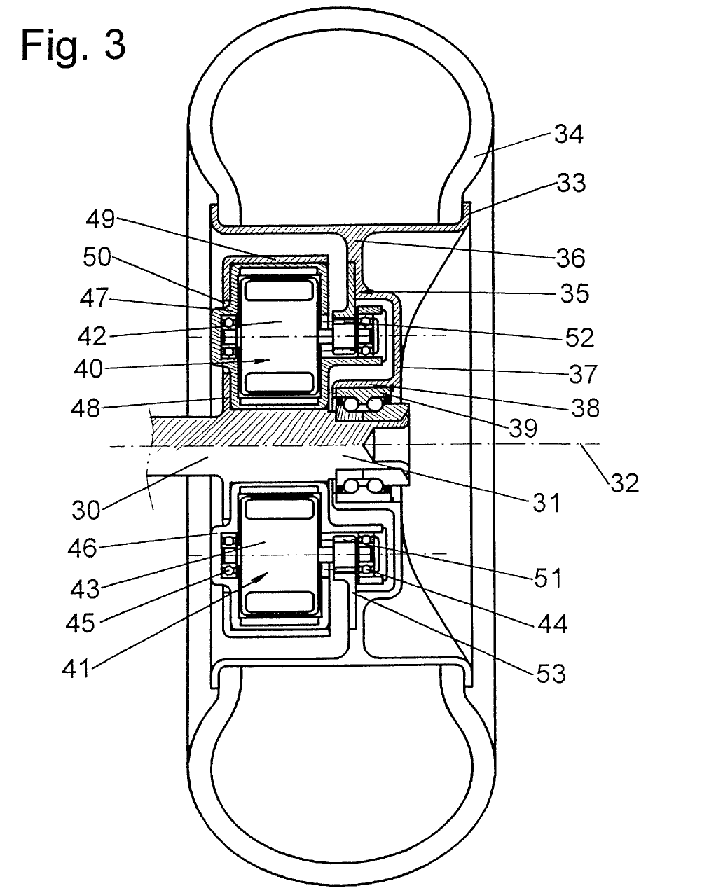

Referring now to FIG. 3, this shows an alternative arrangement in which, as before, there is a shaft 30 providing a hub 31. Mounted on the hub 31 for rotation about its rotary axis 32 is a wheel rim 33 carrying a tire 34. The wheel rim 33 is carried by a disc 35 which has a first portion 36 connected directly to the rim 33 and a second portion 37, parallel to but offset from the portion 36, which has an in-turned flange 38. A double-row ball bearing 39 is inserted between the flange 38 and the hub 31 so that the rim 33 is rotatably mounted on the shaft 30.

As before, there are two electric motors 40 and 41 which are arranged to drive the rim 33 and are equi-angularly spaced about the rotary axis 32 when viewed along the axis 32. The motors 40, 41 are of the pancake type, the rotors of the motors being indicated at 42 and 43 respectively. The rotors 42, 43 are rotatable about respective rotary axes parallel to the rotary axis 32 of the wheel rim 33. Each rotor 42, 43 is mounted in a pair of spaced ball bearings, shown for the rotor 43 at 44 and 45. These bearings are held in the stator 46 of the motor 41, the stator of the motor 40 being shown at 47. The shaft 30 is provided with a flange 48 which is perpendicular to the axis 32 and which has a cylindrical flange 49 at its outer edge. The stators 46 and 47 are received between the hub 31 and the cylindrical flange 49. The flange 48 is apertured, for example, at 50, to give passage to the part of the stator which contains the bearings for the rotor.

Each rotor 42, 43 carries a planet gear 51 or 52 and these planet gears engage in an annulus gear 53, which is carried by the part 36 of the disc 35. As the planet gears 52, 53 are rotated, the annulus gear 53 will be rotated and thus the rim 33 will be rotated.

From the foregoing, it can be seen that there has been brought to the art a new and improved electric wheel motor assembly that has a simplified construction and is efficient. While the invention has been described in connection with one or more embodiments, it should be understood that the invention is not limited to those embodiments. Thus, the invention covers all alternatives, modifications, and equivalents as may be included in the spirit and scope of the appended claims.

What is claimed is:

1. An electric wheel motor assembly comprising:
a hub;
a wheel rim having a rotary axis, mounted on the hub and rotatable about the rotary axis of the wheel rim;
an annulus gear fixed to the wheel rim;
at least two electric motors, each having a stator and a rotor, the rotors being rotatable about rotary axes parallel to the rotary axis of the wheel rim, the stators being fixed to the hub and being spaced apart equi-angularly around the rotary axis of the wheel rim; and
a planet gear driven by each rotor, each planet gear engaging the annulus gear, such that when the rotors rotate, the wheel rim is rotated about its rotary axis.

2. An assembly according to claim 1 wherein the stators are mounted on the hub, and the wheel rim is carried by a disc, the disc being mounted on the hub by a bearing.

3. An assembly according to claim 1 wherein the electric motors are of the pancake type.

4. An assembly according to claim 2 wherein the electric motors are of the pancake type.

5. An electric wheel motor assembly comprising:
a hub;
a wheel rim having a rotary axis, mounted on the hub and rotatable about the rotary axis of the wheel rim;
a sun gear fixed to the hub;
at least two electric motors, each having a stator and a rotor, the rotors being rotatable about rotary axes parallel to the rotary axis of the wheel rim, the stators being fixed to the wheel rim and being spaced apart equi-angularly around the rotary axis of the wheel rim; and
a planet gear driven by each rotor, each planet gear engaging the sun gear such that when the rotors rotate, the wheel rim is rotated about its rotary axis.

6. An assembly according to claim 5 wherein the wheel rim is supported on the hub by the stators, the stators being connected by a ring at their radially inner ends and there being disposed a bearing between the ring and hub.

7. An assembly according to claim 5 wherein the electric motors are of the pancake type.

8. An assembly according to claim 6 wherein the electric motors are of the pancake type.

9. An assembly according to claim 5 comprising a tire mounted on the wheel rim defining an airspace therebetween.

10. An assembly according to claim 9 wherein at least a portion of the electric motors extend radially beyond a joint between the tire and the wheel rim.
